(19) United States
(12) Patent Application Publication
(10) Pub. No.: US 2021/0213536 A1
(43) Pub. Date: Jul. 15, 2021

(54) METHOD FOR PREPARING THE UPPER SURFACE OF AN ADDITIVE MANUFACTUIRNG PLATEN BY DEPOSITING A BED OF POWDER

(71) Applicant: AddUp, Cebazat (FR)

(72) Inventor: JEAN-BAPTISTE MOTTIN, CEBAZAT (FR)

(21) Appl. No.: 17/058,311

(22) PCT Filed: May 23, 2019
(86) PCT No.: PCT/FR2019/051194

§ 371 Date: Nov. 24, 2020

(30) Foreign Application Priority Data
May 25, 2018 (FR) 1854445

(51) Int. Cl. B22F 12/30; B33Y 10/00; B22F 10/28; B33Y 70/00; B33Y 80/00; B22F 1/00; B22F 10/64; B23K 26/352; B33Y 30/00; B23K 26/359; B23K 26/144

(52) U.S. Cl. CPC B22F 12/30; B33Y 10/00; B22F 10/28; B33Y 70/00; B33Y 80/00; B22F 1/0011; B22F 2999/00; B23K 26/3584; B33Y 30/00; B23K 26/359; B23K 26/144; B22F 2304/10; B22F 10/64

(57) ABSTRACT

Method for preparing the upper surface of a build platform for additive manufacturing by powder bed deposition, the method comprises at least one step of increasing the roughness of at least one region of the upper surface of the build platform by imprinting a pattern onto this region. The imprinting of the pattern is done inside the machine for additive manufacturing by powder bed deposition in which the build platform is subsequently used for additive manufacturing by powder bed deposition.

### BACKGROUND

The invention falls within the field of powder-based additive manufacturing by melting grains of this powder with the aid of one or more sources of energy or of heat, such as a laser beam and/or a beam of electrons and/or diodes.

More specifically, the invention falls within the field of additive manufacturing by powder bed deposition and seeks to prepare the build platform supporting various layers of additive manufacturing powder inside a powder bed deposition additive manufacturing machine.

More specifically still, the invention aims to improve the quality of the first layer of powder deposited on the additive manufacturing build platform. Indeed, in the context of additive manufacturing by powder bed deposition, the quality of the first powder layer deposited on the build platform is essential to guarantee a good metallurgical bond between the items to be manufactured and this build platform.

The quality of the first layer of powder is to be understood as the quality of distribution of this first layer of powder on the upper surface of the build platform. In more detail, the objective is to obtain a first layer of powder uniformly distributed over the entire upper surface of the additive manufacturing build platform, that is to say a first layer of powder offering a substantially constant powder thickness at all points of the upper surface of the additive manufacturing build platform.

Various parameters can influence the quality of this first layer of powder: the particle size of the powder, the chemical composition of the powder, the degree of humidity of the powder, the type of device used to spread the powder (scraper or roller, for example), the surface finish of the upper surface of the build platform, etc.

As is known, additive manufacturing build platforms are machined and ground before being mounted in the additive manufacturing machine, in order to have the desired parallelism tolerance between the lower surface and the upper surface of the build platform.

In order to obtain a good-quality first layer, it is known practice to degrade the surface condition of the upper surface of the build platform by sandblasting or by machining (milling for example) in order to increase the roughness of the upper surface of the build platform. The roughness created in this manner makes it possible to retain the powder grains on the upper surface of the additive manufacturing build platform, thus facilitating the adhesion of the first layer of powder on the build platform and therefore obtaining a first uniformly distributed powder layer.

These two methods of the prior art have the drawback of requiring a sandblasting or machining machine, and the consumables necessary for the use of these machines.

### SUMMARY

The present invention therefore provides a method of preparing a build platform for additive manufacturing by powder bed deposition that does not require a sandblasting or machining machine or consumables to increase the roughness of the upper surface of the build platform.

To that end, the invention relates to a method for preparing the upper surface of a build platform for additive manufacturing by powder bed deposition, this method comprising at least one step of increasing the roughness of at least one region of the upper surface of the build platform by imprinting a pattern onto this region.

More particularly, the preparation method provides that the imprinting of the pattern is done inside the machine for additive manufacturing by powder bed deposition in which the build platform is subsequently used for additive manufacturing by powder bed deposition, the imprinting of the pattern being done before a layer of powder is spread over the build platform.

Advantageously, the preparation method provides that the pattern is imprinted onto the upper surface of the build platform with the same source of energy or of heat which is subsequently used to selectively melt the powder, this source preferably being a source emitting at least one laser beam.

The preparation method according to the invention also provides that:
the pattern is raised up above the upper surface of the build platform,
the pattern comprises at least one plurality of juxtaposed lines,
the lines are straight, parallel and regularly spaced apart from one another,
the spacing between two adjacent lines is between 1 and 5 millimetres,
the pattern comprises a first group of juxtaposed lines and a second group of juxtaposed lines, at least one line of the first group intersecting at least one line of the second group,
the lines of the first group being straight, parallel and regularly spaced, and the lines of the second group being straight, parallel and regularly spaced, the lines of the first group intersect the lines of the second group in such a way that the pattern takes the form of a grid,
the lines of the first group are perpendicular to the lines of the second group,
the lines are continuous,
the machine for additive manufacturing by powder bed deposition comprising at least one powder spreading device that moves in a longitudinal direction over the build platform, a plurality of lines of the pattern extend parallel to a transverse direction that is not perpendicular to the longitudinal direction,
a plurality of lines of the pattern extend parallel to a transverse direction whose clockwise or counterclockwise angle of inclination with respect to the longitudinal direction is between twenty-five and sixty-five degrees,
the lines of a first group of lines of the pattern extend parallel to a first transverse direction that is inclined at forty-five degrees in the clockwise direction with respect to the longitudinal direction, and the lines of a second group of lines of the pattern extend parallel to a second transverse direction that is inclined at forty-five degrees in the counterclockwise direction with respect to the longitudinal direction,
the pattern comprising a plurality of juxtaposed elementary cells, each elementary cell has a contour that is at least partially closed,
the contour of each elementary cell is closed over at least 50% of its length,
the contour of each elementary cell is closed over all of its length,
the surface area of each elementary cell is between 4 and 25 mm²,
the pattern is imprinted onto all of the surface of the additive manufacturing build platform.

The present invention also covers a process for additive manufacturing by powder bed deposition, comprising a step of preparing a build platform, this being carried out in accordance with this preparation method.

### BRIEF DESCRIPTION OF THE FIGURES

Further features and advantages of the invention will become apparent in the description which follows. This description, given by way of non-limiting example, refers to the appended drawings, in which:

FIG. 1 is a schematic face-on view of an additive manufacturing machine according to the invention,

FIG. 2 is a sectional view of a pattern imprinted into a build platform according to the method according to the invention,

FIG. 3 is a top view of an additive manufacturing build platform prepared according to the method according to the invention and with a pattern of the open type,

FIG. 4 is a top view of an additive manufacturing build platform prepared according to the method according to the invention and with a pattern of the closed type,

FIG. 5 is a detail view of a pattern having triangular-shaped closed elementary cells,

FIG. 6 is a detail view of a pattern made up of crenellated lines and partially closed elementary cells,

FIG. 7 is a detail view of a pattern made up of sinusoidal lines and partially closed elementary cells, and

FIG. 8 is a detail view of a pattern made up of closed elementary cells of ellipsoidal shape.

### DETAILED DESCRIPTION

The invention relates to a method for preparing a build platform used in an additive manufacturing machine for the implementation of a process of additive manufacturing by powder bed deposition.

Additive manufacturing by powder bed deposition is an additive manufacturing process in which one or more items are manufactured by the selective melting of various mutually superposed layers of additive manufacturing powder. The first layer of powder is deposited on a support such as a platform, then selectively sintered or melted using one or more sources of energy or of heat along a first horizontal section of the item or items being manufactured. Next, a second layer of powder is deposited on the first layer of powder which has just been melted or sintered, and this second layer of powder is selectively sintered or melted in its turn, and so on, until the last layer of powder of use in the manufacture of the last horizontal section of the item or items being manufactured.

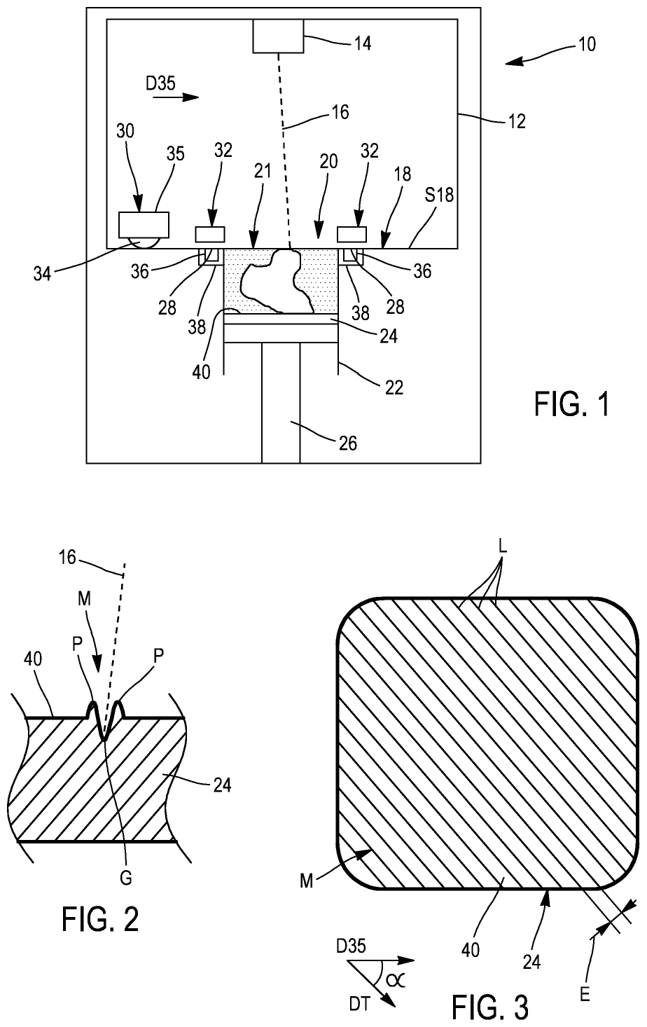

FIG. 1 illustrates an additive manufacturing machine 10 making it possible to implement additive manufacturing of items by depositing a bed of powder. This additive manufacturing machine 10 comprises a build chamber 12 and at least one source 14 of heat or of energy used to selectively, via one or more beams 16, melt (fuse) a layer of an additive manufacturing powder deposited inside the build chamber 12.

The heat or energy source or sources 14 may adopt the form of sources capable of producing one or more beams of electrons and/or one or more laser beams. These sources are, for example, one or more electron guns and/or one or more sources able to emit a laser beam. In order to allow selective fusion and therefore allow the beam or beams 16 of energy or of heat to be moved, each source 14 comprises means for moving and controlling the beam or beams 16.

The build chamber 12 is a closed chamber. One wall of this build chamber 12 may comprise a window so that the manufacturing progress within the chamber can be observed. At least one wall of this build chamber 12 comprises an opening providing access to the inside of the chamber for maintenance or cleaning operations, it being possible for this opening to be sealed closed again by a door during a manufacturing cycle. During a manufacturing cycle, the build chamber 12 may be filled with an inert gas such as nitrogen in order to prevent the additive manufacturing powder from oxidizing and/or in order to avoid risks of explosion. The build chamber 12 may be maintained at a slight overpressure in order to avoid the ingress of oxygen, or may be maintained under vacuum to avoid powder escaping to the outside, or when an electron beam is used inside the chamber to sinter or fuse the powder.

Inside the build chamber 12, the additive manufacturing machine 10 comprises: a horizontal working plane 18 and at least one build zone 20 situated in the working plane 18. A build zone 20 is defined by an opening 21 made in the horizontal working plane 18 and by a build sleeve 22 and a build platform 24. The sleeve 22 extends vertically beneath the working plane 18 and opens into the working plane 18 via the opening 21. The build platform 24 slides vertically inside the build sleeve 22 under the effect of an actuator 26 such as a ram.

In order to create the various layers of powder of use in the additive manufacture of the item or items being manufactured, the additive manufacturing machine comprises two mobile powder receiving surfaces 28 that are able to move in the vicinity of the build zone 20 situated inside the build chamber. The additive manufacturing machine also comprises a powder spreading device 30 that serves to spread the powder from the mobile receiving surfaces 28 towards the build zone 20, and a powder distribution device 32 provided above each mobile receiving surface 28.

The spreading device 30 adopts the form of a scraper and/or of one or more rollers 34 mounted on a carriage 35. This carriage 35 is mounted with the ability to move in translation in a longitudinal direction D35 above the build zone 20. In order to be driven in translation in the longitudinal direction D35, the carriage 35 may be motorized, or set in motion by a motor situated inside, or preferably outside, the build chamber 12 and via a movement-transmission system such as pulleys and a belt.

A mobile powder receiving surface 28 takes the form of a slide 36 mounted to move in translation in a direction preferably perpendicular to the longitudinal direction D35 of movement of the carriage 35 of the powder spreading device 30. In more detail, a slide 36 moves between a retracted position in which this slide is situated outside of the trajectory of the powder spreading device 30, and a deployed position in which this slide extends at least in part into the trajectory of the powder spreading device 30.

A powder distribution device 32 is provided above each slide 36, and therefore above each mobile receiving surface 28.

Each drawer 36 is mounted to move in translation in a groove 38 provided in the working plane 18 of the build chamber 12 near the build zone 20. Each slot 38 is arranged in such a way that the mobile powder-receiving surface 28 formed by each slide moves in the working plane 18. In other words, when a slide 36 is in the deployed position, the receiving surface 28 formed by this slide is situated in the continuation of the upper surface S18 of the working plane.

By being mounted with the ability to move in translation near the build zone 20 and in the working plane 18, each slide 36 occupies a very small amount of space in the vicinity of the build zone 20.

Because each mobile receiving surface 28 adopts the form of a translationally mobile slide, the build zone 20 is preferably rectangular in shape and the build platform 24 is preferably parallelepipedal. However, the build zone 20 and hence the build platform 24 may also adopt other shapes better suited to the shapes of the item or items being manufactured, such as a circular, oval or annular shape for example.

With a view to producing the first layer of powder on the build platform 24, a powder distribution device 32 deposits a line of powder on the mobile receiving surface 28. To that end, the mobile receiving surface 28 moves beneath the powder distribution device 32 and the powder distribution device 32 delivers a stable and controlled rate of flow of powder at least at one distribution point beneath which the mobile powder receiving surface 28 moves. Then, the scraper and/or the roller(s) of the powder spreading device spread the line of powder over the build platform 24, and more precisely on the upper surface 40 of this platform.

The present invention relates to a method for preparing the upper surface 40 of an additive manufacturing build platform 24 aimed at ensuring a homogeneous distribution of the first layer of powder on this build platform.

To that end, the preparation method comprises at least one step of increasing the roughness of at least one region of the upper surface 40 of the build platform 24 by imprinting a pattern M onto this region.

Moreover, the preparation method according to the invention provides that the imprinting of the pattern M is done inside the machine 10 for additive manufacturing by powder bed deposition in which the build platform 24 is subsequently used for additive manufacturing by powder bed deposition. According to the invention, the imprinting of the pattern M is done before a layer of powder is spread over the build platform 24.

By avoiding the use of a sandblasting or machining machine and consumables, the cost of preparing the build platform 24 is reduced. In addition, by creating the pattern M directly in the machine that is subsequently used for carrying out the process of additive manufacturing by powder bed deposition, the time required for preparing this build platform 24 is also reduced.

In more detail, the machine 10 for additive manufacturing by powder bed deposition comprising at least one source of energy or of heat 14 which is used to selectively melt a layer of additive manufacturing powder, the preparation method according to the invention provides that the pattern M is imprinted onto the upper surface 40 of the build platform with the source of energy or of heat 14 which is subsequently used to selectively melt the powder.

In still greater detail, the machine 10 for additive manufacturing by powder bed deposition comprising at least one source 14 emitting at least one laser beam 16 which is used to selectively melt a layer of additive manufacturing powder, the pattern M is imprinted onto the upper surface 40 of the build platform 24 with a laser beam 16 which is subsequently used to selectively melt the powder.

The use of the laser beam 16 which is subsequently used to selectively melt the powder guarantees good precision in the creation of the pattern M and good repeatability in the creation of this pattern M.

The good precision of creation of the pattern M and the good repeatability of the creation of this pattern M are also guaranteed by the mounting of the build platform in the machine, which implies a referencing of the build platform in relation to the source of energy or of heat 14, and therefore precise positioning of the build plate relative to the source of energy or of heat 14.

In order to create roughness, that is to say relief shapes, making it possible to retain the powder grains on the upper surface 40 of the build platform, the preparation method provides for the pattern M to be raised above the upper surface of the build platform.

FIG. 2 illustrates the creation of a pattern M on the upper surface 40 of the build platform with a laser beam 16. For reasons of readability, the dimensional proportions between the pattern M and the thickness of the build platform 24 are not respected and they do not correspond to reality. In more detail, at the point of impact of the beam on the build platform 24, the material of the build platform is melted and pushed back by the energy of the beam. This results in a pattern M formed in the upper surface 40 by at least one protuberance P, two in the example shown in FIG. 2. These protuberances are formed from the material of the build platform. These protuberances P are raised above the upper surface 40 and they extend in at least a direction parallel to the upper surface 40 of the build platform 24. This or these protuberances P may adjoin a channel G hollowed out by the action of the laser beam in the upper surface 40 of the build platform. To give an idea of scale, the protuberance or protuberances P rise a few tens of micrometres above the upper surface 40, while the thickness of a build platform 24 is several centimetres. It is these protuberances P which will make it possible to retain the powder grains on the upper surface 40 of the plate 24 when subject to the action of the powder spreading device 30.

According to a first variant obtained with a very reduced power of the laser beam, a pattern M is formed above the upper surface 40 of the build platform 24 by a single protuberance P obtained by pushing back material. According to other variants obtained with a higher power of the laser beam, a pattern M is formed above the upper surface 40 of the build platform 24 by a single protuberance P adjoining a channel G or by two protuberances P situated on either side of a channel G.

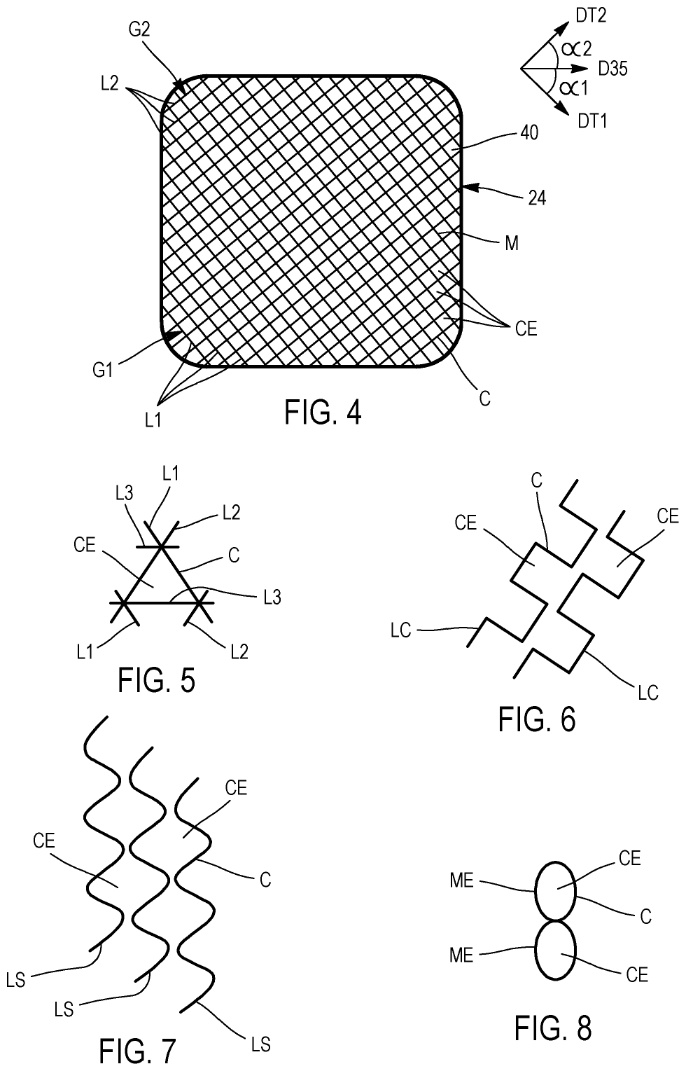

As illustrated in FIG. 3, the pattern M comprises at least one plurality of juxtaposed lines L. For reasons of legibility in FIGS. 3 and 4, the dimensional proportions between the lines L of the pattern M and the dimensions (length and width) of the build platform 24 are not respected and they do not correspond to reality.

To reduce the time necessary for preparing the build platform and to promote uniform distribution of the powder on the build platform 24, the lines L are preferably straight, parallel and regularly spaced apart from one another.

To give an idea of scale, and to allow the adhesion of powders having a particle size of less than one hundred micrometres, the spacing E between two adjacent lines L is preferably between 1 and 5 millimetres.

As shown in FIG. 4, and in order to further promote uniform distribution of the powder on the build platform 24, the pattern M comprises a first group G1 of juxtaposed lines L1 and a second group G2 of juxtaposed lines L2, at least one line L1 of the first group intersecting at least one line L2 of the second group.

Preferably, the lines L1 of the first group G1 being straight, parallel and regularly spaced, and the lines L2 of the second group G2 being straight, parallel and regularly spaced, the lines of the first group intersect the lines of the second group in such a way that the pattern M takes the form of a grid. A grid of this kind forms a plurality of elementary cells CE that serve to greatly promote adhesion of the first layer of powder on the build platform 24.

Still with a view to further promoting a uniform distribution of the powder on the build platform 24, the lines L1 of the first group G1 are preferably perpendicular to the lines L2 of the second group G2.

To reduce the working time of the laser and hence the time for preparing the build platform 24, the lines L, L1, L2 are preferably continuous.

To ensure that the lines L, L1, L2 permit good retention of the powder grains when subject to the action of the powder spreading device 30, at least a plurality of lines L of the pattern M extend parallel to a transverse direction DT that is not perpendicular to the longitudinal direction D35.

Preferably, both the lines L1 of the first group G1 and the lines L2 of the second group G2 extend parallel to respective transverse directions DT1 and DT2 that are not perpendicular to the longitudinal direction D35.

To ensure that the lines L, L1, L2 permit optimal retention of the powder grains when subject to the action of the powder spreading device 30, at least a plurality of lines L, L1, L2 of the pattern M extend parallel to a transverse direction DT, DT1, DT2 whose clockwise or counterclockwise angle of inclination α, α1, α2 with respect to the longitudinal direction D35 is between twenty-five and sixty-five degrees.

In a variant of the pattern M capable of allowing even distribution of those powders which are difficult to spread uniformly (because of a very small particle size, for example less than twenty micrometres, or because of their high degree of humidity), the lines L1 of a first group G1 of lines of the pattern M extend parallel to a first transverse direction DT1 that is inclined at forty-five degrees in the clockwise direction with respect to the longitudinal direction D35, and the lines L2 of a second group G2 of lines of the pattern M extend parallel to a second transverse direction DT2 that is inclined at forty-five degrees in the counterclockwise direction with respect to the longitudinal direction D35.

In order to multiply the elementary cells CE and as illustrated in FIG. 5, it is possible to increase the number of groups G1, G2, G3 of lines L1, L2, L3 which intersect each other, three groups of lines in the example shown. In this example, an elementary cell CE is triangular in shape.

As a variant, non-rectilinear lines can be used to create closed or partially closed elementary cells CE.

FIG. 6 illustrates an exemplary pattern M in which crenellated lines LC are used to create a plurality of partially closed elementary cells CE.

FIG. 7 illustrates an exemplary pattern M in which sinusoidal lines LS are used to create a plurality of partially closed elementary cells CE.

In another variant, illustrated for example in FIG. 8, the pattern M is formed by a plurality of elementary patterns ME which can correspond substantially to the elementary cells CE. Like the elementary cells CE, the elementary patterns ME may have a closed or partially closed contour. Like the elementary cells CE, the elementary patterns ME may be of different shapes: ellipsoidal (FIG. 8), circular, polygonal, in particular in the shape of a parallelogram, a rhombus, a hexagon, etc.

Whether formed from lines or by elementary patterns ME, the pattern M comprises a plurality of juxtaposed elementary cells CE and each elementary cell CE has a contour C that is at least partially closed, in order to make it possible to effectively retain the first layer of powder on the build platform.

In order to guarantee good adhesion of the first layer of powder on the build platform 24, the contour C of each elementary cell is closed over at least 50% of its length.

With a view to optimum distribution of the powders having a particle size of less than one hundred micrometres, the surface area of each elementary cell CE is between 4 and 25 mm².

Generally, the aim is to optimize the use of the upper surface 40 of the build platform 24 during additive manufacturing by powder bed deposition. Also, the pattern M is preferably imprinted onto the entire upper surface 40 of the additive manufacturing build platform.

The present invention covers a build platform 24 for additive manufacturing by powder bed deposition, which is prepared in accordance with the above-described preparation method. In comparison with the build platforms that have undergone sandblasting or machining with the aim of creating roughness by removal of material, the build platform 24 prepared in accordance with the invention is differentiated by the roughness created by protuberances P raised above the upper surface 40 of the build platform and offering better retention of the powder grains than hollow shapes such as micro-grooves or microcavities.

The present invention also covers an additive manufacturing process by powder bed deposition, comprising a step of preparing the build platform 24 implemented in accordance with the above-described preparation method. Such a manufacturing process is for example implemented inside an additive manufacturing machine 10 comprising a build platform 24, a device 30 for spreading a layer of additive manufacturing powder on this build platform, and at least one source of energy or of heat 14 used to selectively melt a layer of additive manufacturing powder.

According to this manufacturing process, the build platform 24 is mounted in the additive manufacturing machine 10 then prepared in accordance with the above-described preparation method.

Still according to this manufacturing process, the build platform 24 is prepared in accordance with the above-described preparation method, then subsequently used for the additive manufacturing of items by powder bed deposition.

Ideally, according to this manufacturing process, the build platform 24 is mounted in the additive manufacturing machine 10, prepared in accordance with the above-described preparation method, and then used for the additive manufacturing of items by powder bed deposition.

The preparation method, the build platform 24 prepared with this method, and the additive manufacturing process incorporating this preparation method, are of particular interest when they are used with powders having a particle size of less than 50 micrometres because they make it possible to guarantee a homogeneous distribution of such powders even if their particle size is relatively small.

1.-23. (canceled)

24. A method for preparing the upper surface of a build platform for additive manufacturing by powder bed deposition, the method comprising at least one step of:
increasing the roughness of at least one region of the upper surface of the build platform by imprinting a pattern onto the at least one region,
wherein the imprinting of the pattern is performed inside a machine for additive manufacturing by powder bed deposition in which the build platform is subsequently used for additive manufacturing by powder bed deposition, and
wherein the imprinting of the pattern is performed before a layer of powder is spread over the build platform.

25. The method according to claim 24, wherein the machine for additive manufacturing by powder bed deposition comprises at least one source of energy or of heat which is used to selectively melt a layer of additive manufacturing powder, and the pattern is imprinted onto the upper surface of the build platform with the source of energy or of heat which is subsequently used to selectively melt the powder.

26. The method according to claim 24, wherein the machine for additive manufacturing by powder bed deposition comprises at least one source emitting at least one laser beam which is used to selectively melt a layer of additive manufacturing powder, and the pattern is imprinted onto the upper surface of the build platform with a laser beam which is subsequently used to selectively melt the powder.

27. The method according to claim 24, wherein the pattern is raised up above the upper surface of the build platform.

28. The method according to claim 24, wherein the pattern comprises at least one plurality of juxtaposed lines.

29. The method according to claim 28, wherein the lines are straight, parallel and regularly spaced apart from one another.

30. The method according to claim 29, wherein the spacing between two adjacent lines is between 1 and 5 millimeters.

31. The method according to claim 28, wherein the pattern comprises a first group of juxtaposed lines and a second group of juxtaposed lines, at least one line of the first group intersecting at least one line of the second group.

32. The method according to claim 31, wherein the lines of the first group are straight, parallel and regularly spaced and the lines of the second group are straight, parallel and regularly spaced, and the lines of the first group intersect the lines of the second group in such a way that the pattern takes the form of a grid.

33. The method according to claim 32, wherein the lines of the first group are perpendicular to the lines of the second group.

34. The method according to claim 28, wherein the lines are continuous.

35. The method according to claim 28, wherein the machine for additive manufacturing by powder bed deposition comprises at least one powder spreading device that moves in a longitudinal direction over the build platform, and a plurality of lines of the pattern extend parallel to a transverse direction that is not perpendicular to the longitudinal direction.

36. The method according to claim 35, wherein a plurality of lines of the pattern extend parallel to a transverse direction, a clockwise or counterclockwise angle of inclination of which with respect to the longitudinal direction is between twenty-five and sixty-five degrees.

37. The method according to claim 36, wherein lines of a first group of lines of the pattern extend parallel to a first transverse direction that is inclined at forty-five degrees in the clockwise direction with respect to the longitudinal direction, and wherein lines of a second group of lines of the pattern extend parallel to a second transverse direction that is inclined at forty-five degrees in the counterclockwise direction with respect to the longitudinal direction.

38. The method according to claim 24, wherein the pattern comprises a plurality of juxtaposed elementary cells, and each elementary cell has a contour that is at least partially closed.

39. The method according to claim 38, wherein the contour of each elementary cell is closed over at least 50% of the length of each elementary cell.

40. The method according to claim 39, wherein the contour of each elementary cell is closed over all of the length of each elementary cell.

41. The method according to claim 38, wherein a surface area of each elementary cell is between 4 and 25 mm².

42. The method according to claim 24, wherein the pattern is imprinted onto all of the upper surface of the additive manufacturing build platform.

43. A process for additive manufacturing by powder bed deposition, the additive manufacturing process being carried out inside an additive manufacturing machine comprising a build platform, a spreading device for spreading a layer of additive manufacturing powder over the build platform, and at least one source of energy or of heat which is used to selectively melt a layer of additive manufacturing powder, the process comprising a step of:
preparing the build platform according to the method according to claim 24.

44. The process according to claim 43, wherein the build platform is mounted in the additive manufacturing machine before the preparing step.

45. The process according to claim 43, wherein after the preparing step, the build platform is used for the additive manufacturing of items by powder bed deposition.

46. The process according to claim 43, wherein the additive manufacturing powder used by the manufacturing process has a grain size of less than 50 micrometers.
